(19) United States
(12) Patent Application Publication
(10) Pub. No.: US 2005/0060364 A1
(43) Pub. Date: Mar. 17, 2005

(54) System and method for over the air (OTA) wireless device and network management

(76) Inventors: Rakesh Kushwaha, Marlboro, NJ (US); Srinivas Devarakonda, Keasbey, NJ (US); Badri Nath, Edison, NJ (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/886,005

(22) Filed: Jul. 7, 2004

Related U.S. Application Data
(60) Provisional application No. 60/484,660, filed on Jul. 7, 2003.

(51) Int. Cl. G06F 15/16

(52) U.S. Cl. 709/200

(57) ABSTRACT

A system and method for wireless device management in a telecommunications network that includes a wireless device and a server. An agent executing on a wireless identity module that is operatively connected to the wireless device communicates with a service manager executing on the server. The information communicated by the agent may include the identity of the wireless device, the network identity of the wireless identity module, the physical location of the wireless device in the telecommunications network, the signal strength and bit error rate of the primary communication channel used by the wireless device, and a list of features supported by the wireless device. The service manager may then monitor the wireless device, and may proactively query the wireless device via the agent to ascertain the status of the wireless device and the quality of service provided to the wireless device by the telecommunications network.

### RELATED APPLICATIONS

This application claims priority under 35 U.S.C. § 119(e) to U.S. Provisional Application Ser. No. 60/484,660, entitled “A METHOD AND PROTOCOL FOR OVER THE AIR (OTA) WIRELESS DEVICE MANAGEMENT USING A SIM AGENT AND TLV MESSAGES,” filed on Jul. 7, 2003, under attorney docket number 19527.0011 which is herein incorporated by reference in its entirety.

### BACKGROUND OF INVENTION

1. Field of Invention

The present invention relates wireless devices, and more particularly, to a system and method for over the air (OTA) wireless device and/or network management, including QOS (Quality of Service) monitoring of the performance of a wireless device, a wireless network, and/or applications for various 2G/2.5G/3G wireless networks.

2. Discussion of Related Art

Wireless devices, such as cell phones, pagers, Personal Digital Assistants (PDAs), PCMCIA devices, personal computers, etc. provide an environment for deploying/executing voice, data, and/or voice and data applications. Early wireless devices (e.g., Second Generation (2G) devices) and networks were generally limited to voice only communications and to specific applications. For example, it was not uncommon to witness a person having both a cell phone and a separate pager, as each were designed for a specific purpose; one for cellular voice communication, and the other to receive short text messages. Typically, each such wireless device had its own identity in the form of a unique number, such as a telephone number, with which it communicated with a wireless communication network. Because the use of early wireless devices was relatively limited and quite specific to the type of device, any application or network software relating to such wireless devices was also relatively limited and quite specific.

Newer wireless devices (e.g., Second and a half Generation (2.5G) and Third Generation (3G) wireless devices) and networks are now available that enable a single wireless device to have multiple uses. For example, 2.5G wireless devices and networks permit a single wireless device to communicate voice and text messages, as well as permitting a user to access web services using a packet based network, and 3G wireless devices add to such capabilities by providing a high bandwidth packet based communications.

Some of these newer wireless devices utilize what is termed a Subscriber Identity Module (SIM), a Universal Subscriber Identity Module (USIM), or a smart-card, each of which contains a unique identifier, termed an International Mobile Subscriber Identity (IMSI) that enables the wireless device to which it is attached to communicate with wireless communication networks throughout the world. Some of these SIM/USIM/smart cards may also be used with different types of wireless devices, such that at one moment in time they may be connected to one type of device, for example, a cell phone, and at another moment in time, they may be connected to a different type of device, for example, a Personal Desktop Assistant (PDA), while utilizing the same globally unique identifier (IMSI).

### SUMMARY OF INVENTION

According to one aspect of the present invention, a monitoring system for a telecommunications network is provided. The monitoring system comprises a processor, a network adapter, and a memory. The network adapter is interconnected to the processor to interface the processor with the telecommunications network, and the memory is interconnected to the processor and the network adapter to store computer program instructions. The computer program instructions, when executed by the processor, perform a method comprising acts of receiving a first message from a wireless device over a first communication channel of the telecommunications network, the first message uniquely identifying at least one of the wireless device and a network identity of a wireless identity module operatively connected to the wireless device, and monitoring at least one of a status of the wireless device and a quality of service provided by telecommunications network to the wireless device.

According to another aspect of the present invention, a method for use in a telecommunications network that comprises a server and a wireless device is provided. The wireless device has a wireless identity module operatively connected thereto, and the method comprises acts of establishing a communication between the server and the wireless identity module over a communication channel of the telecommunications network, and sending, over the communication channel, a message identifying at least one of a status of the wireless device and a quality of service provided to the wireless device by the telecommunications network to the server.

According to one embodiment, the act of sending may include sending a registration message to a service manager process executing on the server that uniquely identifies the wireless device, a network identity of the wireless identity module, a physical location of the wireless device in the telecommunications network, and a signal strength and bit error rate of the communication channel. According to another embodiment, the method may further comprise acts of receiving a second message from the wireless device uniquely identifying the wireless device and each feature of a plurality of features that are supported by the wireless device, and receiving, over a second communication channel of the telecommunications network, at least one third message identifying at least one first feature of the plurality of features supported by the wireless device that the service manager desires to monitor.

According to another aspect of the present invention, a computer readable medium is provided that is encoded with a program that, when executed on a processor of a server that is operatively connected to a telecommunications network, performs a method. The method comprises acts of receiving a first message from a wireless device over a first communication channel of the telecommunications network, the first message uniquely identifying at least one of the wireless device and a network identity of a wireless identity module operatively connected to the wireless device, and monitoring at least one of a status of the wireless device and a quality of service provided by telecommunications network to the wireless device.

According to further aspect of the present invention, a computer readable medium is provided that is encoded with a program. The program, when executed on a processor of a wireless identity module that is operatively connected to a wireless device, performs a method comprising acts of establishing a communication between a server and the wireless identity module over a communication channel of a telecommunications network; and sending, over the communication channel, a message identifying at least one of a status of the wireless device and a quality of service provided to the wireless device by the telecommunications network to the server.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an exemplary block diagram of a network system in which embodiments of the present invention may be implemented;

FIG. 2a illustrates a wireless device that may be used in the network system of FIG. 1 and that includes a wireless identity module;

FIG. 2b is an exemplary block diagram of wireless identity module on which a management agent may be implemented in accordance with one aspect of the present invention;

FIG. 3 is an exemplary block diagram of a server computer system on which a service manager may be implemented in accordance with another aspect of the present invention;

FIG. 4 is an exemplary flow diagram of a management routine that may be performed by a management agent in accordance with one aspect of the present invention; and

FIG. 5 is an exemplary flow diagram of a management routine that may be performed by a service manager in accordance with another aspect of the present invention.

### DETAILED DESCRIPTION

Various embodiments and aspects thereof will now be discussed in detail with reference to the accompanying figures. It is to be appreciated that this invention is not limited in its application to the details of construction and the arrangement of components set forth in the following description or illustrated in the drawings. The invention is capable of other embodiments and of being practiced or of being carried out in various ways. Examples of specific implementations are provided herein for illustrative purposes only. In particular, acts, elements and features discussed in connection with one embodiment are not intended to be excluded from a similar role in other embodiments. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

As used herein, the term Wireless Device (WD) refers to any wireless device, including, but not limited to a cell phone, a pager, a PDA (Personal Desktop Assistant), a PCMCIA card, a set-top box, a laptop, notebook, or other type of computer, or any other type of electronic device that communicates with another device over a wireless network. The term Wireless Identity Module (WIM) refers to a Subscriber Identity Module (SIM), a Universal Subscriber Identity Module (USIM), a smart-card, or any other type of electronic module that contains a globally unique identifier, frequently termed an International Mobile Subscriber Identity (IMSI), that uniquely identifies the wireless identity module (WIM), and which enables a wireless device (WD) to which it is attached to communicate with wireless communication networks throughout the world. The IMSI is an international wireless network communication number assigned to a wireless identity module (WIM), similar in concept to a MAC address for an Ethernet LAN adapter or an internationally unique mobile phone number. The term Integrated Circuit Card Identifier (ICCD) refers to a unique identifier, assigned to a wireless identity module (WIM), that uniquely identifies the manufacturer and serial number of the wireless identity module (WIM). The term International Mobile Equipment Identity (IMEI) refers to a unique identifier used by a wireless device (WD). The IMEI of a wireless device is similar, in concept, to a Vehicle Identification Number (VIN) for automobiles in that it uniquely identifies the (wireless) device by manufacturer, model number, and serial number in a globally unique manner. A listing of the IMEIs for various wireless devices is maintained by the Global System for Mobile communications (GSM). It should be appreciated that, rather than an IMEI, some wireless devices may utilize a serial number or Equipment Serial Number (ESM) for a similar purpose. For non-GSM wireless network devices, these serial numbers are assigned by their respective manufacturers.

In broad overview, embodiments of the present invention are directed to a system and method for enabling OTA remote wireless device and network management, including Quality of Service (QOS) monitoring of wireless networks, applications, and wireless device performance for various 2G/2.5G/3G wireless networks. In accordance with an aspect of the present invention, management functions are carried out by the use of an agent (a “management agent,” as used herein) that executes on a wireless identity module, such as a SIM, USIM, smart card, etc., and which interacts over the air with a service manager executing on a server using a communication protocol that is based on exchanging packets between the management agent and the service manager. This communication protocol may use a tag (markup) based protocol to transmit messages between the management agent and the service manager.

In one embodiment, a Tag/Length/Value (TLV) structure is used, although the present invention is not so limited, as other protocols and structures, such as SGML, HTML, WML, or XML may be used. The underlying over the air transport mechanism used for communication between the management agent and the service manager may be SMS, IP, UDP, HTTP, or any other communication protocol supported by the wireless device and the wireless identity module to which it is attached. Information, such as the condition and status of the wireless device, the wireless network, and applications that is communicated by the management agent to the service manager conveys the Quality of Service that an end user receives on a 2G/2.5G/3G wireless network.

Initially, when the management agent is deployed, it is activated based upon the terminal profile of the wireless device to which it is connected. Depending on the features that the wireless device supports (as defined in the wireless device's terminal profile), the management agent then registers for events with the wireless device and sends a Registration message to the service manager executing on the server. The service manager can then initiate monitoring commands to monitor one or a number of events that may be of interest to the service manager. Examples of events that may be of interest to the service manager include changes in the physical location of the wireless device, voice/data coverage changes, abnormal voice/data call disconnects, and other QOS (quality of service) indicators. In one embodiment, messages originated by the management agent contain location information identifying the physical location of the wireless device, the wireless device's IMEI (or serial number), the wireless identity module's IMSI, as well as a signal strength indicator and Bit Error Rate (BER) identifier.

Attributes and events gathered by the management agent and communicated to the service manager may be broadly classified as Static Device attributes, Static Network attributes, Dynamic Network attributes, other Quality of Service indicators, and Call Control, Connect, and Disconnect events. For example, Static Device Attributes may include attributes such as the wireless device's IMEI (or serial number) and terminal profile, and the wireless identity module's IMSI and ICCID. Static Network Attributes may include, for example, attributes such as the Signal Strength and Bit Error Rate (BER), while Dynamic Network Attributes may include attributes such as P-TMSI (a packet channel identifier that will only be present if the wireless communication network to which the wireless device is attached is a packet based network) and Location information indicative of the physical location of the wireless device, from which the service manager may determine if the wireless device is in a home network or a roaming network. In addition to the Signal Strength and the Bit Error Rate, other Quality of Service indicators may, for example, include opening a channel to activate a Packet Data Protocol (PDP) context and query dynamic QOS information, issuing an AT command from the wireless identity module to query for other signal strength indicators, such as RSSI available on 3G networks, as well as other 3G QOS parameters, or to query for frame error rates or other link layer performance primitives. Call Control, Connect, and Disconnect events may be used to identify the type of call (Voice vs. Video) based on the baud rate of the connection, or to identify errors in call connect and disconnect for a particular call, for example.

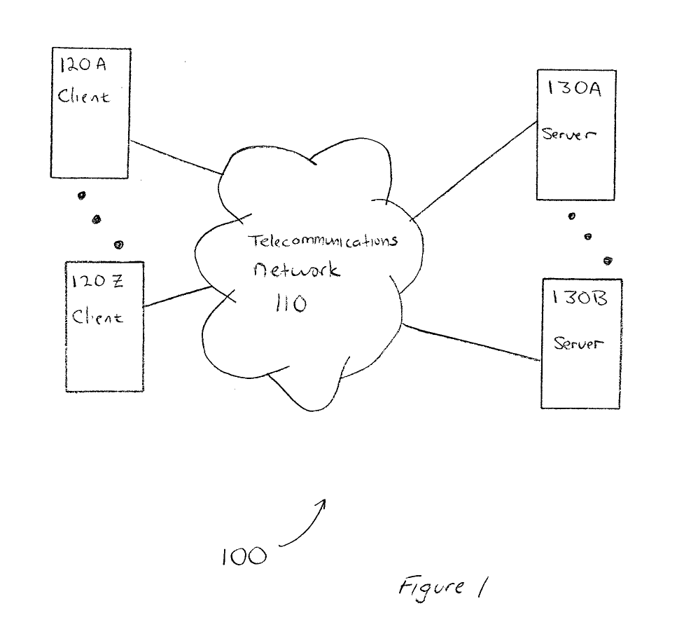

An exemplary block diagram of a network system 100 in which the present invention may be implemented is shown in FIG. 1. Network system 100 includes a telecommunications network 110 that provides communicative interconnection of a plurality of devices, such as client systems 120A-120Z and server systems 130A-130N. It should be appreciated that the network system 100 may include a myriad of other types of devices, such as bridges, routers, gateways, etc. Telecommunications network 110 may include one or more wireless networks and/or one or more wireline networks. The transmission media in a wireless network is typically electromagnetic radiation, such as radio waves or light, while the transmission media in a wireline network is wire, such as copper wire, or the equivalent of wire, such as fiber optic cable.

The wireless telecommunications networks included in telecommunications network 110 may include, for example, digital cellular telephone networks, such as Global System for Mobile Telecommunications (GSM) networks, Personal Communication System (PCS) networks, etc. The wireline telecommunications networks included in telecommunications network 110 may include, for example, the Public Switched Telephone Network (PSTN), as well as proprietary local and long distance telecommunications networks. In addition, telecommunications network 110 may include digital data networks, such as one or more local area networks (LANs), one or more wide area networks (WANs), or both LANs and WANs. One or more networks may be included in telecommunications network 110 and may include both public networks, such as the Internet, and private networks and may utilize any networking technology and protocol, such as Ethernet, Token Ring, Transmission Control Protocol/Internet Protocol (TCP/IP), etc.

Client systems 120A-120Z may include any type of electronic data processing system or communication device. Examples of such electronic data processing systems and communication devices include personal computer systems, such as desktop or laptop computers, workstation computer systems, server computer systems, networks of computer systems, personal digital assistants (PDAs), set top boxes, pagers, pcmcia cards, cellular telephones, etc. The client systems 120A-120Z may connect directly to network 110, or may connect indirectly to network 110 through one or more other networks, gateways, firewalls, etc. Likewise, the connection to network 110 may be wired, wireless, or a combination of wired and wireless.

Telecommunications network 110 may include one or more communications channels that may carry a variety of communications traffic, such as telephone voice and data calls, packet-based data traffic, and signaling data relating to the telecommunications traffic and the configuration of telecommunications network 110. For example, the communications channels may include General Packet Radio Service (GPRS) communication channels, Circuit Switch Data (CSD) communications channels, etc.

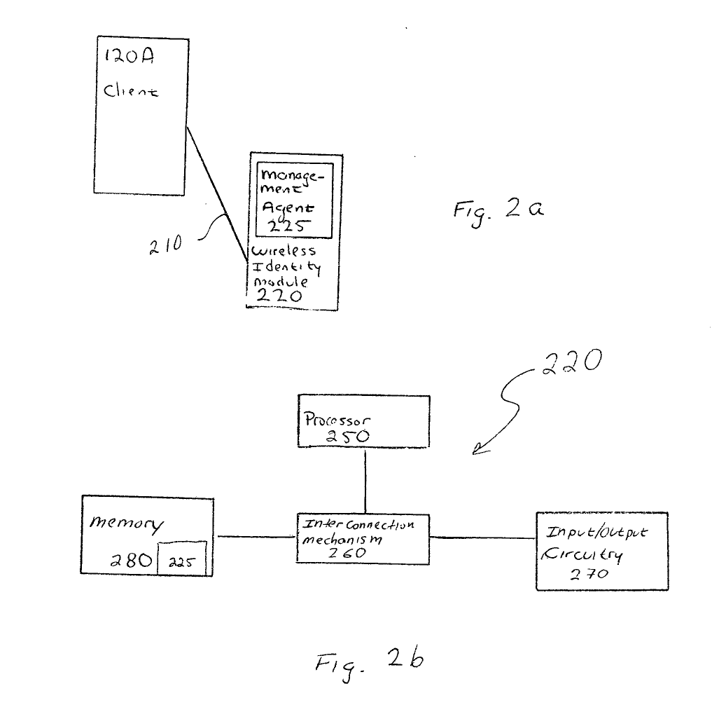

According one aspect of the present invention, one or more of the client systems 120A-120Z may be wireless devices that communicate with the telecommunications network 110 using wireless technology, and which utilize a wireless identity module, such as a SIM, a USIM, a smart card, etc. For example, as shown in FIG. 2a, one or more of the client systems of FIG. 1, (e.g., client system 120A) may be a wireless device that is connected to a wireless identity module 220 via a connector 210. The connector 210 typically provides power to the wireless to the wireless identity module 220, and also provides a physical interface by which the client system 120A may communicate with the wireless identity module 220. In accordance with one embodiment of the present invention, the wireless identity module 220 may include a management agent 225 that executes on the wireless identity module, and that can communicate with a service manager executing on a server system.

As illustrated in FIG. 2b, the wireless identity module 220 generally includes a processor or CPU 250, input/output circuitry 270, and a memory 280 interconnected by way of an interconnect mechanism 260, such as one or more busses. Other components may also be interconnected, as the present invention is not limited to the illustrated components. Typically, the processor or CPU 250 is a general purpose microprocessor from Motorola, AMD, Intel, etc., although the present invention is not limited to any particular type of processor. Input/output circuitry 270 provides the capability to input data to, or output data from, client system 120A. The input/output circuitry may include buffers, UARTS, or other types of data communication circuits and supporting circuitry, as known to those skilled in the art.

Memory 280 stores program instructions that are executed by, and data that is used and processed by the processor or CPU 250, and may be used to store a management agent program 225 in accordance with the present invention. Memory 280 may include any type of electronic memory device, but will generally include some amount of random-access memory (RAM), such as Dynamic RAM (DRAM), or Static RAM (SRAM), as well as some amount of read-only memory (ROM), such as programmable read-only memory (PROM), electrically erasable programmable read-only memory (EEPROM), flash memory, etc.

Software, including programming code that implements embodiments of the present invention, is generally stored in memory 280 and then executed by the processor or CPU 250. Such programming code may be written in any of a plurality of programming languages, for example, Java, Visual Basic, C, C#, or C++, Fortran, Pascal, Eiffel, Basic, COBAL, or any of a variety of combinations thereof, including proprietary software development environments provided by wireless identity module manufacturers or variations thereof. It should be appreciated that although the management agent is described herein in terms of software, it should be appreciated that it may be implemented in software, hardware or firmware, or any combination thereof.

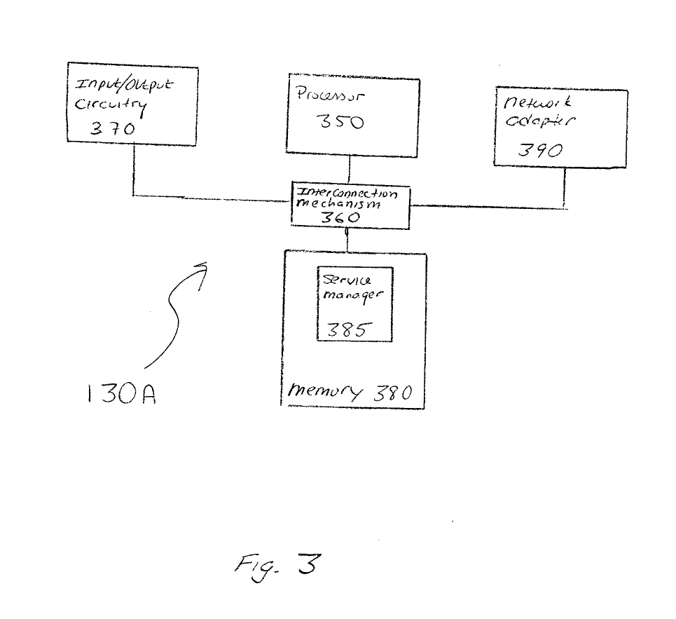

An exemplary block diagram of a server system on which embodiments of the present invention may be implemented is shown in FIG. 3. Server system 130A is typically a programmed general-purpose computer system, such as a personal computer, a workstation, a server system, such as those based on an Intel PENTIUM®-type processor, a Motorola PowerPC® processor, a Sun UltraSPARC® processor, a Hewlett-Packard PA-RISC® processor, or any other type of processor known to those skilled in the art. Alternatively, server system may be a minicomputer or a mainframe computer, for example, an IBM mainframe computer. Server system 130A generally includes one or more processors (CPU) 350, input/output circuitry 370, a network adapter 390, and memory 380 interconnected by an interconnection mechanism 360, such as a bus, or a number of busses.

Although the server system 130A depicted in FIG. 3 depicts a single processor computer system, it should be appreciated that the present invention is not so limited, as the server system 130A may alternatively be implemented as a multi-processor system in which multiple processors share system resources, such as memory 380, input/output circuitry 370, and network adapter 390. The present invention also contemplates embodiments in which server system 130A is implemented as a plurality of networked computer systems, which may be single-processor computer systems, multi-processor computer systems, or a mix thereof.

Input/output circuitry 370 provides the capability to input data to, or output data from, server system 130A, and may include input devices, such as keyboards, mice, touchpads, trackballs, scanners, etc., output devices, such as video adapters, monitors, printers, etc., and input/output devices, such as, modems, etc. Network adapter 390 may interface server system 130A directly with the telecommunications network 110 (FIG. 1), or alternatively, may interface the server system 130A with a gateway (not shown), which communicatively connects the server system with a channel of the telecommunications network 110.

Memory 380 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc. Memory 380 is typically used for storing programs and data during operation of the server system 130A, such as a service manager program 385, discussed in detail further below. Software, including programming code that implements embodiments of the present invention, is generally stored on a computer readable and/or writeable nonvolatile recording medium, and then copied into memory 380 wherein it may then be executed by the processor 350. Such programming code may be written in any of a plurality of programming languages, or combinations thereof, as the present invention is not limited to a particular programming language. Typically, in operation, the processor 350 causes data, such as code that implements embodiments of the present invention, to be read from a nonvolatile recording medium into another form of memory, such as RAM, that allows for faster access to the information by the processor than does the nonvolatile recording medium.

Although server system 130A is shown by way of example as one type of computer system upon which various aspects of the invention may be practiced, it should be appreciated that embodiments of the present invention are not limited to being implemented in software, or on the server system as shown in FIG. 3. Indeed, rather than being implemented on a general purpose computer system, embodiments of the present invention may alternatively be implemented as a dedicated system or as a dedicated programmable logic controller (PLC). Further, it should be appreciated that aspects of the invention may be implemented in software, hardware or firmware, or any combination thereof. Thus, for example, embodiments of the present invention may comprise any computer-readable medium (e.g., a computer memory, a floppy disk, a compact disk, a tape, etc.) encoded with a computer program (i.e., a plurality of instructions), which, when executed on a processor, performs the functions of the management agent and/or the service manager described in detail more fully below.

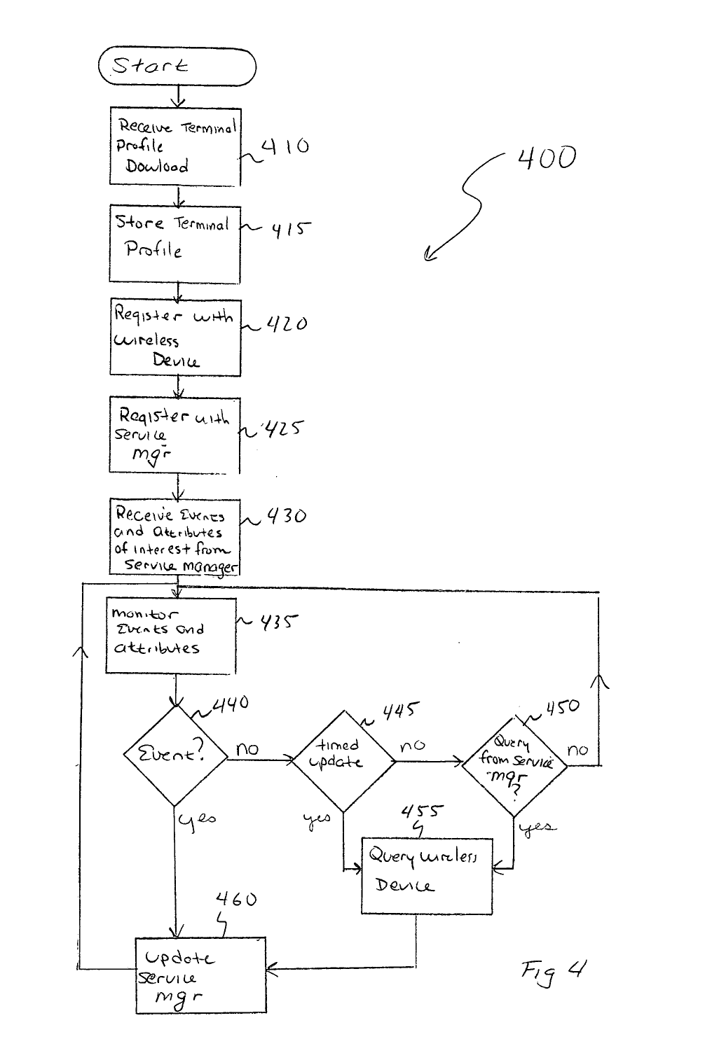

FIG. 4 illustrates a wireless identity module management routine that may be executed on a wireless identity module (WIM) in accordance with one exemplary embodiment of the present invention. The management routine may be executed by an agent program (termed a “management agent” herein) that executes on the wireless identity module (e.g., wireless identity module 220 in FIG. 2a) and may be used to provide information relating to the wireless device (e.g., wireless device or client system 120A in FIG. 2a) to which it is connected, the performance and/or attributes of the wireless communication network to which the wireless device is connected or may communicate with, and/or applications that may be executed by the wireless device to which it is connected.

Upon power-up of the wireless device and the wireless identity module to which it is connected, the wireless device sends a communication to the wireless identity module in the form of a terminal profile download. The terminal profile download (referred to by various standards bodies, such as the 3^{rd} Generation Partnership Project (3GPP) and the European Telecommunications Standards Institute (ETSI) simply as a “Profile Download”) is communicated to the wireless identity module using a Packet Data Unit (PDU) protocol over a separate communication channel that is specified by the above-referenced standards bodies.

The terminal profile download provided by the wireless device to the wireless identity module includes the International Mobile Equipment Identity (IMEI) or other serial number of the wireless device, as well as a list of features that are supported by the wireless device. The list of features that is provided by the wireless device to the WIM generally includes those features specified by various standards bodies, such as 3GPP and ETSI for wireless identity devices such as SIMs, USIMs, etc. These features may include whether the wireless device supports SMS point to point download (SMS-PP download), as well as various other communication protocols, such as USSD, DTMF, TCP, UDP, etc. The list of features provided by the wireless device generally includes both events and proactive features that are supported by the wireless device, as well as attributes of the wireless device and/or the communication network to which it may be connected. An exemplary, but abbreviated listing of features supported by various wireless devices is provided in Tables I and II below, with Table I identifying 2.5 G features, and with Table II identifying 3G features. It should be appreciated that the features listed Tables I and II is abbreviated, and there are many other features, some of which are presently defined, and others that are reserved for future use (RFU), that are not listed.

TABLE I
Phase 2+ WIM Feature List and their Device Support

| Fea- | | | | | | |
|---|---|---|---|---|---|---|
| ture | | RIM | XDA- | Nk | Nk | SE |
| No. | Feature | 5820 | UK | 7650 | 6310i | T200 |
| 0 | Profile download | Yes | Yes* | Yes | Yes | Yes |
| 1 | SMS-PP data download | Yes | Yes | Yes | Yes | Yes |
| 2 | Cell Broadcast data | Yes | Yes | Yes | Yes | Yes |
| | download | | | | | |
| 3 | Menu selection | Yes | No | Yes | Yes | Yes |
| 5 | Timer Expiration | No | Yes | No | No | No |
| 6 | USSD string data object | No | Yes | No | No | No |
| | supported in Call Control | | | | | |
| 8 | command result | Yes | Yes | Yes | Yes | Yes |
| 9 | Call Control by SIM | Yes | Yes | No | No | No |
| 10 | Cell identity included in | No | Yes | No | No | No |
| | Call Control by SIM | | | | | |
| 11 | MO short message control | No | Yes | No | No | No |
| | by SIM | | | | | |
| 16 | Proactive SIM: Display | Yes | No | Yes | Yes | Yes |
| | Text | | | | | |
| 17 | Proactive SIM: Get Inkey | Yes | No | Yes | Yes | Yes |
| 18 | Proactive SIM: Get Input | Yes | No | Yes | Yes | Yes |
| 25 | Proactive SIM: Send Short | Yes | Yes | Yes | Yes | Yes |
| | Message | | | | | |
| 26 | Proactive SIM: Send SS | Yes | No | Yes | Yes | Yes |
| 27 | Proactive SIM: Send USSD | No | No | Yes | Yes | Yes |
| 30 | Proactive SIM: Provide | Yes | Yes | Yes | Yes | Yes |
| | Local Information | | | | | |
| 31 | Proactive SIM: Provide | No | Yes | Yes | Yes | No |
| | Local Information (NMR) | | | | | |
| 32 | Proactive SIM: Set Up | No | Yes | No | Yes | No |
| | Event List | | | | | |
| 33 | Event: MT call | No | Yes | No | No | No |
| 34 | Event: Call connected | No | Yes | No | No | No |
| 35 | Event: Call disconnected | No | Yes | No | No | No |
| 36 | Event: Location status | No | Yes | No | Yes | No |
| 37 | Event: User activity | No | No | No | No | No |
| 38 | Event: Idle screen | No | No | No | No | No |
| | available | | | | | |
| 39 | Event: Card reader status | No | No | No | No | No |
| 57 | Proactive SIM: Timer | No | Yes | No | No | No |
| | Management (get cur. | | | | | |
| | value) | | | | | |
| 58 | Proactive SIM: Provide | No | No | Yes | Yes | No |
| | Local Info (date, time . . . ) | | | | | |
| 61 | Run AT Command | No | Yes* | No | No | No |
| 65 | Send DTMF | No | Yes | No | No | No |
| 66 | Proactive SIM: Provide | No | Yes | Yes | Yes | No |
| | Local Information (BCCH) | | | | | |

TABLE II
3GPP/UMTS WIM Feature List and their Device Support

| Fea- | | | | | | |
|---|---|---|---|---|---|---|
| ture | | RIM | XDA- | Nk | Nk | SE |
| No. | Feature | 5820 | UK | 7650 | 6310i | T200 |
| 7 | Automatic Redial Mode | No | No | No | No | No |
| 40 | Lanuage Selection | No | No | No | No | No |
| 41 | Browser Termination | No | No | No | No | No |
| 42 | Data Available | No | No | No | No | No |
| 43 | Channel Status | No | No | No | No | No |
| 52 | Proactive SIM: Get Reader | No | No | No | No | No |
| | Status | | | | | |
| 67 | Provide Local Info. | No | No | No | No | No |
| | (language) | | | | | |
| 68 | Provide Local Info. | No | No | No | No | No |
| | (Timing Advance) | | | | | |
| 69 | Language Notification | No | No | No | No | No |
| 70 | Launch Browser | No | No | No | No | No |
| 80 | Open Channel | No | No | No | No | No |
| 81 | Close Channel | No | No | No | No | No |
| 82 | Receive Data | No | No | No | No | No |
| 83 | Send Data | No | No | No | No | No |
| 84 | Channel Status | No | No | No | No | No |
| 88 | CSD supported by ME | No | No | No | No | No |
| 89 | GPRS supported by ME | No | No | No | No | No |
| 93 | No. of channels supported | No | No | No | No | No |
| | by ME | | | | | |
| 96 | No. of chars down the ME | No | No | No | No | No |
| | display | | | | | |
| 103 | Screen sizing parameters | No | No | No | No | No |
| 104 | No. of chars across the ME | No | No | No | No | No |
| | display | | | | | |
| 111 | Variable Size fonts | No | No | No | No | No |
| | supported | | | | | |
| 120 | TCP | No | No | No | No | No |
| 121 | UDP | No | No | No | No | No |
| 136 | Protocol Version | No | No | No | No | No |
| 151 | RFU | No | No | No | No | No |

The format of the terminal profile download generally includes the IMEI (or serial number) of the wireless device, followed by a bit string (e.g., 111011101 . . . ) identifying which of the various features specified by the standards bodies, such as 3GPP and ETSI are supported by the wireless device, based upon the position, and value, of each bit in the bit string. For example, a first bit value (e.g., 1) for the second bit in the bit string identifies that the wireless device supports feature 2 (SMS-PP download), whereas a second bit value (e.g., 0) would identify that this feature is not supported by the wireless device.

At step 410 the management agent receives the IMEI (or serial number) and bit string provided by the wireless device in the terminal profile download and proceeds to step 415. At step 415, the management agent stores the terminal profile download provided by the wireless device, at least temporarily, in a memory (e.g., memory 280 in FIG. 2b) that is local to the wireless identity module. This memory may be a volatile memory, such as RAM, or alternatively, may be a non-volatile memory that is capable of storing data across power cycles of the wireless identity module and the wireless device.

At step 420, the management agent sends a registration message or communication to the wireless device identifying which of the enumerated features that are supported by the wireless device and which are defined as “events” in the standards the wireless identity module wishes to be alerted to by the wireless device. As with the previous terminal profile download, this communication, and indeed, all communications between the wireless device and the wireless identity module, uses a Packet Data Unit (PDU) protocol over a separate communication channel that is specified by the above-mentioned standards bodies.

In general, those features defined as “events” in the applicable standard correspond to those features that a wireless device may report to a wireless identity module upon the occurrence of the specified event. These may include a call connected event (feature 34), a call disconnected event (feature 35), a location status event (feature 36), a user activity event (feature 37), as well as other features specified as events in the standards. After registering with the wireless device for events, the management agent proceeds to step 425.

At step 425 the management agent sends a registration message or communication to a service manager executing on a server. The registration message sent by the management agent identifies the wireless device to which the wireless identity module is attached by its IMEI or other serial number, and includes the terminal profile previously received from the wireless device at step 410. In addition to the IMEI (or serial number) and the terminal profile of the wireless device, the registration message may also include additional information of interest to the service manager. In accordance with one embodiment, this additional information may include location information identifying the physical location of the wireless device, the IMSI of the wireless identity module, a signal strength indicator indicative of the strength of the communication signal being used by the wireless device to communicate with a base station, and a Bit Error Rate (BER) indicator indicative of the bit error rate of the communication channel used by the wireless device to communicate with the base station.

The registration message communicated by the management agent to the service manager may use any of a number of different underlying communication protocols to communicate with the service manager, such as Short Message Service (SMS), User Datagram Protocol (UDP), Internet Protocol (IP), HyperText Transfer Protocol (HTTP), etc, provided that the communication protocol is supported by the wireless device and the communication network to which the wireless device may be connected.

As used herein, the expression wireless identity module originated (WIM originated) message refers to those communications sent by the management agent to the service manager. The expression wireless identity module terminated (WIM terminated) message refers to those communications sent by the service manager to the management agent. In general, for both WIM originated messages and WIM terminated messages, packets may be exchanged using a mark-up language (i.e., a tag along with some text indicating to the recipient what to do with the tag), such as HTML, SGML, WML, XML, etc. In general each of these languages may be expressed as a Tag/Length/Value (TLV) triplet and be communicated over another underlying communication protocol such as SMS, UDP, IP, HTTP, etc. Both WIM originated messages and WIM terminated messages may generally have a format: <Format ID+Payload Length+Payload>.

For example, a WIM originated message using the SMS protocol as the underlying over the air transport mechanism may have a format: <Format ID+SMS Header+Common Header+Payload> where the Format ID represents the payload included in the message (for example, the registration message could have a Format ID of 1, a Call disconnect could have a Format ID of 2, etc.), and where the Common header includes Location information, the IMEI (or serial number) of the wireless device, the IMSI of the wireless identity module, signal strength, and the Bit Error Rate (BER) along with the length of the payload. Where the WIM originated message is a registration message, the payload will include terminal profile of the wireless device received at step 415.

In response to the registration message sent at step 425, the service manager may initiate monitoring commands to monitor any one, or a number of events or attributes that are of interest to the service manager. These events or attributes may be communicated to the management agent by the service manager in a single command, or as a series of commands. The service manager may also monitor other features or attributes of the wireless device or the communication network as described more fully below. Events that may be of interest to the service manager may include changes in the physical location of the wireless device, voice/data coverage changes, abnormal voice/data call disconnects, and other QOS (quality of service) indicators.

As with WIM originated messages, WIM terminated messages (e.g, those messages sent by the service manager or another entity to the WIM) may also have a format <Format ID+Payload Length+Payload>. Examples of commands that may be sent by the service manager may include commands, such as “Get” or “Show” a particular feature or attribute of the wireless device or the communication network to which it may be connect, or “Get” or “Show” all supported features or attributes of the wireless device or the communication network, “Start” or “Stop” network coverage monitoring, call monitoring, or other event monitoring, etc. In general, the service manager may monitor any events and features that are of interest to the service manager, such as those events and/or features relating to the quality of service that the wireless device is receiving. It should be appreciated that the ability of an entity, such as the service manager, to monitor the quality of service a wireless device is receiving may allow wireless service providers to pinpoint weaknesses in their service and take remedial action. For example, rather than having people wander about the globe and asking “can you hear me now?”, data captured by the service manager may be analyzed to determine weaknesses in wireless service, or alternatively, to determine what enhancements may be provided for a particular network.

In response to receiving a communication at step 430 from the service manager requesting that event monitoring for one or a number of events be performed by the management agent and reported to the service manager, the management agent proceeds to step 435, wherein the management agent then monitors those events and attributes of the wireless device, and/or the communication network requested by the service manager. It should be appreciated that steps 420 and 425 may be performed in the reverse order, such that the wireless identity module registers for events with the wireless device after having been informed by the management server of what events the management service is interested in monitoring.

Steps 440 through 455 illustrate a number of different actions that the management agent may take during the process of monitoring events. For example, in step 440, the management agent may make a determination as to whether the wireless device to which it is attached has notified the wireless identity module of an event, such as a call connected event (feature 34 in Table I). When it is determined that an event has occurred, the management agent may proceed to step 460, wherein the management agent communicates that event to the service manager. Alternatively, when it is determined that no event has occurred, the management agent may proceed to step 445.

At step 445, the management agent may make a determination as to whether a time-out period has expired. For example, at the request of the service manager, or by design of the management agent, the management agent may periodically query the wireless device for updates as to its status and that of the network. This status update may be performed in response to the expiration of a timer that may, for example, be set by the management server. When it is determined in step 445 that the time-out period has expired, the management agent may proceed to step 455, wherein the management agent queries the wireless device for any information that may be of interest to the service manager. Alternatively, when there is no time-out period specified, or when the time-out period has not yet expired, the management agent may proceed to step 450.

At step 450, the management agent makes a determination as to whether it has received a query from the management server. Such a query may correspond to one or more of the features identified as proactive features in the list of features supported by the wireless device.

For example, the management server may request that the management agent query the wireless device to provide local information (feature 30 in Table I). In response to such a command or query from the service manager, the management agent may proceed to step 455 and send a query to the wireless device requesting that such information be provided. In response to a reply from the wireless device, the management agent may then provide this information back to the service manager, by updating the service manager in step 460. After updating the service manager in step 460, the management agent may then return to step 435 and continue monitoring events and features of interest to the service manager.

Alternatively, when it is determined at step 450 that the service manager has not sent a query to the management agent, the management agent may simply return to step 435 and continue monitoring events and features of interest to the service manager.

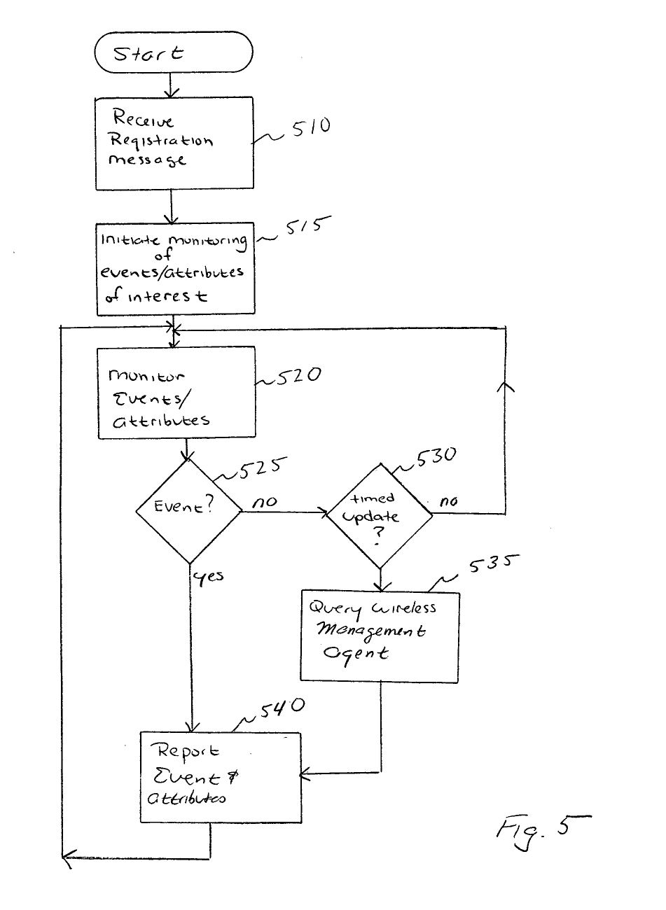

FIG. 5 illustrates a management routine that may be performed by service manager executing on a server system (e.g., server system 130A in FIG. 3 in accordance with one exemplary embodiment of the present invention. Advantageously, the service manager may be used to identify problems in the quality of service offered by network providers, as well as to identify whether those problems are related to a particular type of device (for example, PDAs, or pagers), a particular manufacturer of wireless devices, a particular location within a particular network, etc.

At step 510, the service manager receives a registration message from a management agent. As discussed above with respect to FIG. 4, this registration message will generally include the International Mobile Equipment Identity (IMEI) or other serial number of the wireless device, as well as a list of features that are supported by the wireless device. From this information, the service manager may identify the manufacturer of the wireless device, as well as the model of the wireless device, and may identify what communication protocols and channels are available for communication with the wireless device and the management agent.

As discussed previously with respect to FIG. 4, and in accordance with an embodiment of the present invention, the registration message may also include additional information pertaining to the wireless identity module and the communication network, such as location information identifying the physical location of the wireless device, the IMSI of the wireless identity module, a signal strength indicator indicative of the strength of the communication signal, and a Bit Error Rate (BER) indicator indicative of the bit error rate of the communication channel.

The registration message communicated by the management agent to the service manager may use any of a number of different underlying communication protocols to communicate with the service manager, such as Short Message Service (SMS), User Datagram Protocol (UDP), Internet Protocol (IP), HyperText Transfer Protocol (HTTP), etc, provided that the communication protocol is supported by the wireless device and the communication network to which the wireless device may be connected. For example, because nearly all wireless devices support SMS, the registration message may be sent by the management agent and received by the service manager using SMS. Subsequent communications between the management agent and the service manager may use a different communication protocol, once it has been determined by the service manager that other such protocols are supported by the wireless device.

After receiving the registration message from the management agent, the service manager routine proceeds to step 515, wherein the service manager sends a communication to the management agent identifying those events and/or attributes of interest to the service manager that the service manager wishes to monitor. In general, those events and/or attributes that the service manager routine is interested in monitoring will be based upon those features that are supported by the wireless device, as enumerated in the terminal profile of the device. However, those events and/or attributes may include a default set of events and/or attributes that are common to most wireless devices, and which are indicative of the quality of service being provided to the wireless device.

For example, a default set of events and/or attributes may include location information identifying the physical location of the wireless device, the IMSI of the wireless identity module, a signal strength indicator indicative of the strength of the communication signal, a Bit Error Rate (BER) indicator indicative of the bit error rate of the communication channel, as well as other events/attributes that are common to a number of different types (e.g., phones, pagers, PDA's, etc.) of wireless devices. Such events and/or attributes of interest to the service manager may be broadly classified as Static Device attributes, Static Network attributes, Dynamic Network attributes, Quality of Service indicators, and Call Control, Connect, and Disconnect events. Examples of Static Device Attributes may include attributes such as the wireless device's IMEI (or serial number) and terminal profile, and the wireless identity module's IMSI and ICCID. Examples of Static Network Attributes may include attributes such as the Signal Strength and Bit Error Rate (BER), while Dynamic Network Attributes may include attributes such as whether P-TMSI (a packet channel identifier) is present or has changed. Location information may include information indicative of the physical location of the wireless device, from which the service manager may determine if the wireless device is in a home network or a roaming network. In addition to the Signal Strength and the Bit Error Rate, other Quality of Service indicators may, for example, include opening a channel to activate a Packet Data Protocol (PDP) context and query dynamic QOS information, issuing an AT command from the wireless identity module to query for other signal strength indicators, such as RSSI available on 3G networks, as well as other 3G QOS parameters, or to query for frame error rates or other link layer performance primitives. Call Control, Connect, and Disconnect events may be used to identify the type of call (Voice vs. Video) based on the baud rate of the connection, or to identify errors in call connect and disconnect for a particular call, for example.

After informing the management agent of those events and/or attributes that are of interest to the service manager, the service manager proceeds to step 520, wherein the service manager then monitors those events and attributes of the wireless device, and/or the communication network of interest to the service manager.

Steps 525 through 535 illustrate a number of different actions that the service manager may take during the process of monitoring events and attributes. For example, in step 525, the service manager may make a determination as to whether the management agent has notified the service manager of an event, such as a call connected event (feature 34 in Table I), a user activity event (feature 37 in Table I), or another type of event.

When it is determined that an event has occurred, the service manager may proceed to step 540, wherein the service manager may report that event and any pertinent attributes relating to the wireless device and the network. For example, at step 540, the service manager may write a log file identifying the time of occurrence of the event, the type of event, and any codes associated with the event (e.g., if the event was a call disconnect event, then there are generally a number of reason codes 0 to 128 identifying the reason for the call disconnect), as well as any additional information pertaining to the event, the wireless device, or the network. This additional information may generally include the IMEI (or serial number) of the wireless device, the IMSI of the wireless identity module, the location of the wireless device when the event occurred, the signal strength and the Bit Error Rate when the event occurred, as this information is included in the communication sent by the management agent upon the occurrence of any monitored event.

Should additional information concerning the event, or the status of the wireless device or the network be desired, the service manager may send a query to the management agent, requesting additional information. For example, the service manager could request the management agent to open a channel and activate the PDP context to query dynamic quality of service information, such as, for example, channel availability, the time required to establish a PDP connection, the time required to transfer data, etc., or alternatively, the service manager could request the management agent to issue an AT command (feature 61 in Table I) to query for other quality of service indicators, such as RSSI when the wireless device is in a 3G network, or to query for the frame error rate and other link layer performance primitives. It should be appreciated that depending upon the type of event and the extent to which event/attribute reporting is supported by the wireless device, the operation of the service manager may vary. Thus, for example, upon the occurrence of a normal disconnect event, the service manager may simply report the event and the associated attributes to a log file, whereas for a call disconnect event indicating an abnormal disconnect, the service manager may request further information from the management agent.

Alternatively, when it is determined at step 525 that no event has occurred, the service manager may proceed to step 530. At step 530, the service manager may make a determination as to whether a time-out period has expired. For example, rather than relying upon the management agent to periodically update the service manager, the service manager may proactively query the management agent to provide an update as to its status, the status of the wireless device, the status of the network to which the wireless device is connected, or each of the above. This status update may be performed in response to the expiration of a timer that may, for example, be set to a desired value by a user of the server system. It should be appreciated that such a timer should not be set to too low a value so as to interfere with the operation of the wireless device.

When it is determined in step 530 that the time-out period has expired, the service manager may proceed to step 535, wherein the service manager may query the management agent for any information that may be of interest to the service manager. In response to the management agent providing the requested information, the service manager may proceed to step 540, wherein that information may be reported, for example, in a log file. Alternatively, when there is no time-out period specified, or when the time-out period has not yet expired, the service manager agent may return to step 520 and continue monitoring events. After reporting events, attributes, and/or other information in step 540, the service manager may return to step 520 and continue monitoring events and or attributes.

It should be appreciated that the events, attributes, and other information reported in step 540 may be periodically reviewed, either manually, or by a computerized program to identify problems with the quality of service experienced by wireless devices. By analyzing such information, service providers can identify problems in network service, as well as determine whether those problems are related to a particular type, or manufacturer of a wireless device, etc.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A method for use in a telecommunications network that comprises a server and a wireless device, the wireless device having a wireless identity module operatively connected thereto, the method comprising acts of:
establishing a communication between the server and the wireless identity module over a communication channel of the telecommunications network; and
sending, over the communication channel, a message identifying at least one of a status of the wireless device and a quality of service provided to the wireless device by the telecommunications network to the server.

2. The method of claim 1, wherein the message is a first message, the method further comprising an act of:
receiving a second message from the wireless device uniquely identifying the wireless device and each feature of a plurality of features that are supported by the wireless device.

3. The method of claim 1, wherein the message is a first message, the method further comprising an act of:
sending a second message to the wireless device, requesting that the wireless device inform the wireless identity module of a change in at least one feature of a plurality of features supported by the wireless device.

4. The method of claim 1, wherein the act of sending includes an act of sending a message identifying both the status of the wireless device and the quality of service provided to the wireless device by the telecommunications network to the server.

5. The method of claim 1, wherein the act of sending includes an act of sending a message identifying both the status of the wireless device and the quality of service provided to the wireless device by the telecommunications network to a service manager process executing on the server.

6. The method of claim 5, wherein the message is a first message, the method further comprising an act of:
receiving, over a second communication channel of the telecommunications network, at least one second message identifying at least one first feature of a plurality of features supported by the wireless device that the service manager desires to monitor.

7. The method of claim 6, further comprising an act of:
sending a third message to the wireless device requesting that the wireless device inform the wireless identity module of any change in the at least one first feature of the plurality of features supported by the wireless device that the service manage desires to monitor.

8. The method of claim 7, further comprising acts of:
receiving a fourth message from the wireless device informing the wireless identity module of a change in the at least one first feature of the plurality of features supported by the wireless device that the service manager desires to monitor; and
sending, responsive to the act of receiving the fourth message, a fifth message to the service manager identifying the change in the at least one first feature.

9. The method of claim 5, wherein the wireless identity module includes a processor, and wherein the act of establishing the communication is performed by a management agent executing on the processor of the wireless identity module.

10. The method of claim 9, wherein the act of sending includes an act of sending a registration message to the service manager that uniquely identifies at least one of the wireless device and a network identity of the wireless identity module.

11. The method of claim 10, wherein the registration message further identifies a physical location of the wireless device in the telecommunications network.

12. The method of claim 11, wherein the registration message further identifies a signal strength and bit error rate of the communication channel.

13. The method of claim 12, wherein the registration message further identifies each feature of a plurality of features supported by the wireless device.

14. The method of claim 13, wherein the message is a first message, the method further comprising an act of:
receiving, over a second communication channel of the telecommunications network, at least one second message identifying at least one first feature of the plurality of features supported by the wireless device that the service manager desires to monitor.

15. The method of claim 14, wherein the second communication channel is different from the first communication channel.

16. The method of claim 14, wherein the first message uses SMS protocol, and wherein the second message uses a protocol other than the SMS protocol.

17. The method of claim 14, wherein the at least one first feature includes at least one of a call event, a call connected event, a call disconnected event, a location status event, and a user activity event.

18. The method of claim 14, further comprising an act of:
sending a third message to the wireless device, requesting that the wireless device inform the management agent of any change in the at least one first feature of the plurality of features supported by the wireless device that the service manage desires to monitor.

19. The method of claim 14, further comprising acts of:
receiving a fourth message from the wireless device informing the management agent of a change in the at least one first feature of the plurality of features supported by the wireless device that the service manager desires to monitor; and
sending, responsive to the act of receiving the fourth message, a fifth message to the service manager identifying the change in the at least one first feature.

20. The method of claim 18, further comprising an act of:
receiving, over the second communication channel of the telecommunication network, at least one fourth message requesting the management agent query the wireless device for information relating to at least one second feature of the plurality of features supported by the wireless device that the service manager desires to monitor.

21. The method of claim 20, further comprising an act of:
sending a fifth message to the wireless device querying the wireless device for information relating to the at least one second feature of the plurality of features supported by the wireless device that the service manager desires to monitor.

22. The method of claim 21, further comprising acts of:
receiving, responsive to the act of sending the fifth message, a response from the wireless device; and
sending a sixth message to the service manager that includes the information relating to the at least one second feature received in the response from the wireless device.

23. A computer readable medium, encoded with a program that, when executed on a processor of a wireless identity module that is operatively connected to a wireless device, performs a method comprising acts of:
establishing a communication between a server and the wireless identity module over a communication channel of a telecommunications network; and
sending, over the communication channel, a message identifying at least one of a status of the wireless device and a quality of service provided to the wireless device by the telecommunications network to the server.

24. The computer readable medium of claim 23, wherein the message is a first message, and wherein the method further comprises an act of:
receiving a second message from the wireless device uniquely identifying the wireless device and each feature of a plurality of features that are supported by the wireless device.

25. The computer readable medium of claim 23, wherein the message is a first message, and wherein the method further comprises an act of:
sending a second message to the wireless device, requesting that the wireless device inform the wireless identity module of a change in at least one feature of a plurality of features supported by the wireless device.

26. The computer readable medium of claim 23, wherein the act of sending includes an act of sending a message identifying both the status of the wireless device and the quality of service provided to the wireless device by the telecommunications network to a service manager process executing on the server.

27. The computer readable medium of claim 26, wherein the message is a first message, and wherein the method further comprises an act of:
receiving, over a second communication channel of the telecommunications network, at least one second message identifying at least one first feature of a plurality of features supported by the wireless device that the service manager desires to monitor.

28. The computer readable medium of claim 27, wherein the method further comprises an act of:
sending a third message to the wireless device requesting that the wireless device inform the wireless identity module of any change in the at least one first feature of the plurality of features supported by the wireless. device that the service manage desires to monitor.

29. The computer readable medium of claim 28, wherein the method further comprises acts of:
receiving a fourth message from the wireless device informing the wireless identity module of a change in the at least one first feature of the plurality of features supported by the wireless device that the service manager desires to monitor; and
sending, responsive to the act of receiving the fourth message, a fifth message to the service manager identifying the change in the at least one first feature.

30. The computer readable medium of claim 23, wherein the act of sending includes an act of sending a registration message to a service manager process executing on the server that uniquely identifies the wireless device, a network identity of the wireless identity module, a physical location of the wireless device in the telecommunications network, and a signal strength and bit error rate of the communication channel.

31. The computer readable medium of claim 30, wherein the registration message further identifies each feature of a plurality of features supported by the wireless device.

32. The computer readable medium of claim 31, wherein the message is a first message, the method further comprising an act of:
receiving, over a second communication channel of the telecommunications network, at least one second message identifying at least one first feature of the plurality of features supported by the wireless device that the service manager desires to monitor.

33. The computer readable medium of claim 32, wherein the method further comprises an act of:
sending a third message to the wireless device, requesting that the wireless device inform the wireless identity module of any change in the at least one first feature of the plurality of features supported by the wireless device that the service manage desires to monitor.

34. The computer readable medium of claim 33, wherein the method further comprises acts of:
receiving a fourth message from the wireless device informing the wireless identity module of a change in the at least one first feature of the plurality of features supported by the wireless device that the service manager desires to monitor; and
sending, responsive to the act of receiving the fourth message, a fifth message to the service manager identifying the change in the at least one first feature.

35. The computer readable medium of claim 33, wherein the method further comprises an act of:
receiving, over the second communication channel of the telecommunication network, at least one fourth message requesting the wireless identity module query the wireless device for information relating to at least one second feature of the plurality of features supported by the wireless device that the service manager desires to monitor.

36. The computer readable medium of claim 35, wherein the method further comprises an act of:
sending a fifth message to the wireless device querying the wireless device for information relating to the at least one second feature of the plurality of features supported by the wireless device that the service manager desires to monitor.

37. The computer readable medium of claim 36, wherein the method further comprises acts of:
receiving, responsive to the act of sending the fifth message, a response from the wireless device; and
sending a sixth message to the service manager that includes the information relating to the at least one second feature received in the response from the wireless device.

38. A computer readable medium, encoded with a program that, when executed on a processor of a server that is operatively connected to a telecommunications network, performs a method comprising acts of:
receiving a first message from a wireless device over a first communication channel of the telecommunications network, the first message uniquely identifying at least one of the wireless device and a network identity of a wireless identity module operatively connected to the wireless device; and
monitoring at least one of a status of the wireless device and a quality of service provided by telecommunications network to the wireless device.

39. The computer readable medium of claim 38, wherein the first message uniquely identifies both the wireless device and the network identity of the wireless identity module operatively connected to the wireless device.

40. The computer readable medium of claim 39, wherein the first message further identifies each feature of a plurality of features that are supported by the wireless device.

41. The computer readable medium of claim 40, wherein the act of monitoring includes an act of:
sending a second message over a second communication channel of the telecommunications network to a management agent executing on the wireless identity module requesting that the wireless identity module inform the server of a change in at least one feature of the plurality of features supported by the wireless device.

42. The computer readable medium of claim 39, wherein the act of monitoring includes an act of monitoring both the status of the wireless device and the quality of service provided by the telecommunications network to the wireless device.

43. The computer readable medium of claim 42, wherein the act of monitoring includes an act of:
sending, over a second communication channel of the telecommunications network, at least one second message to a management agent executing on the wireless identity module identifying at least one first feature of a plurality of features supported by the wireless device that a process executing on the server desires to monitor.

44. The computer readable medium of claim 43, wherein the method further comprises acts of:
receiving a third message from the management agent informing the server of a change in the at least one first feature of the plurality of features supported by the wireless device that the process executing on the server desires to monitor; and
reporting, responsive to the act of receiving the third message, the change in the at least one first feature to a file.

45. The computer readable medium of claim 44, wherein the first message further identifies a physical location of the wireless device in the telecommunications network and a signal strength and bit error rate of the first communication channel.

46. The computer readable medium of claim 42, wherein the act of monitoring further includes an act of monitoring performance of applications executed by the wireless device.

47. The computer readable medium of claim 42, wherein the act of monitoring the quality of service provided by the telecommunications network to the wireless device includes an act of monitoring a frame error rate and link layer performance primitives.

48. The computer readable medium of claim 39, wherein the first message further identifies a physical location of the wireless device in the telecommunications network and a signal strength and bit error rate of the first communication channel.

49. The computer readable medium of claim 48, wherein the first message further identifies each feature of a plurality of features supported by the wireless device.

50. The computer readable medium of claim 48, wherein the act of monitoring includes an act of monitoring at least one of the physical location of the wireless device in the telecommunications network, the signal strength of the first communication channel and the bit error rate of the first communication channel.

51. The computer readable medium of claim 49, wherein the act of monitoring includes an act of:
sending, over a second communication channel of the telecommunications network, at least one second message to a management agent executing on the wireless identity module identifying at least one first feature of the plurality of features supported by the wireless device that a process executing on the server desires to monitor.

52. The computer readable medium of claim 51, wherein the method further comprises acts of:
receiving a third message from the management agent informing the server of a change in the at least one first feature of the plurality of features supported by the wireless device that the process executing on the server desires to monitor; and
reporting, responsive to the act of receiving the third message, the change in the at least one first feature to a file.

53. The computer readable medium of claim 52, wherein the act of monitoring further includes an act of:
sending, over the second communication channel of the telecommunication network, at least one fourth message requesting the management agent query the wireless device for information relating to at least one second feature of the plurality of features supported by the wireless device that the process executing on the server desires to monitor.

54. The computer readable medium of claim 53, wherein the act of monitoring further includes acts of:
receiving, responsive to the act of sending the at least one fourth message, the information relating to the at least one second feature; and
reporting, responsive to the act of receiving the information, the information relating to the at least one second feature to a file.
